(19) United States
(12) Patent Application Publication
(10) Pub. No.: US 2017/0276075 A1
(43) Pub. Date: Sep. 28, 2017

(54) SYSTEM AND METHOD TO SELECTIVELY CONTROL DUAL FUEL ENGINE INTAKE AIR TEMPERATURE

(71) Applicant: Electro-Motive Diesel, Inc., La Grange, IL (US)

(72) Inventors: Farhan F. Devani, Morton Grove (IL); Aaron G. FOEGE, Westmont, IL (US); Keith E. MORAVEC, Downers Grove, IL (US); Jonathan G. DOLAK, Elmhurst, IL (US)

(73) Assignee: Electro-Motive Diesel, Inc., La Grange, IL (US)

(21) Appl. No.: 15/077,127

(22) Filed: Mar. 22, 2016

(51) Int. Cl. F02D 41/00; F02B 29/04; F02M 35/10; F02M 21/02; F02M 35/16

(52) U.S. Cl. CPC F02D 41/0002; F02D 41/0027; F02M 21/0215; F02M 35/164; F02M 35/1015; F02B 29/0493; F02B 29/0443; F02M 35/10209

(57) ABSTRACT

A system and method to selectively control intake air temperature of a dual fuel engine are provided. The dual fuel engine intake air temperature is automatically modified based on a determined fuel mode at which the dual fuel engine is operating or instructed to operate.

### TECHNICAL FIELD

The present disclosure relates generally to a dual fuel engine, and in particular, to a system and a method for selectively controlling intake air temperature of a dual fuel engine.

### BACKGROUND

Dual fuel engines can have a condition known as “methane slip,” where natural gas injected into the engine for purposes of displacing diesel fuel does not fully combust. Increasing the engine intake manifold air temperature can increase the combustion reactivity, thereby consuming methane and reducing slip. However, an increase in engine intake manifold air temperature can reduce the knock margin, which, in turn, can reduce the maximum diesel displacement and/or engine horsepower. Generally speaking, for a dual fuel system, knock (i.e., pinging) is produced by an abnormal combustion/detonation of port-injected fuel where some part of the engine fuel is involved in the compression stroke, and the air-fuel mixture in the cylinder gets hot enough to burn on its own before intended, which can cause higher combustion rates and pressure rates that may damage the engine.

U.S. Patent Publication Number 2014/0123917 (hereinafter the '917 publication”) describes a thermal management system for an internal combustion engine where an air intake door is operable to vary combustion intake air temperatures based on operating conditions. According to the '917 publication, the air intake door may be adjustable to a first position that connects the air intake passage with an engine compartment to provide intake air from the engine compartment to the air intake passage, and to a second position that connects the air intake passage with the environment outside of the engine compartment to provide ambient environment air to the air intake passage. Thus, as described in the '917 publication, by adjusting the air intake door to the first position to provide intake air from the engine compartment, combustion intake air temperature may be increased, and by adjusting the air intake door to the second position to provide intake air from the ambient environment, combustion intake air temperature may be decreased. The '917 publication also describes that the air intake door may be automatically adjustable between the first and second positions, using a controller, based on an operating parameter, such as intake air temperature or ambient environment temperature.

### SUMMARY

In one aspect of the present disclosure, a system for selectively controlling temperature of intake air inside an intake manifold of a diesel-natural gas dual fuel engine of a locomotive is provided. The system includes control circuitry, a valve electrically connected to the control circuitry and separating an engine room from a clean air room of the locomotive; and an aftercooler water circuit electrically connected to the control circuitry. The valve is operable to an open position and a closed position, the open position allowing air from the engine room to pass through the valve to the clean air room and the closed position preventing air from the engine room from passing through the valve to the clean air room. The control circuitry is configured to receive a signal indicative of a power level associated with a notch selected by an operator of the locomotive, and receive a signal indicating a fueling mode of the engine, where the fueling mode is one of a diesel only fueling mode and a dual fuel fueling mode. The control circuitry is also configured to control operation of the valve from the closed position to the open position responsive to receipt of the signal indicative of the power level and the signal indicating the fueling mode is the dual fuel fueling mode. Additionally, the control circuitry is configured to control one or more of water flow through the aftercooler water circuit so as to reduce an amount of water flowing through an aftercooler, and airflow to a radiator of the aftercooler water circuit to reduce an airflow rate of air applied to the radiator, responsive to receipt of the signal indicative of the power level and the signal indicating the fueling mode is the dual fuel fueling mode.

In another aspect of the present disclosure, a system for selectively controlling air temperature at an intake manifold of a dual fuel engine is provided. The system includes a valve separating an engine room from a clean air room, where the clean air room has access to an air inlet port to the intake manifold of the dual fuel engine. The system further includes a controller configured to determine a fuel mode of the dual fuel engine and generate a control command based on the determined fuel mode of the dual fuel engine. The system further includes a valve control circuit connected to the valve and in signal communication with the controller. The valve control circuit is configured to operate the valve to an open state, to allow the flow of air from the engine room into the clean air room to be provided to the intake manifold, and to a closed state, to prevent the flow of air from the engine room into the clean air room, responsive to the control command generated based on the determined fuel mode of the dual fuel engine.

In yet another aspect of the present disclosure, a method for selectively modifying temperature of air inside an intake manifold of a dual fuel engine is provided. The method includes receiving a pre-set command, from among a plurality of pre-set commands, for a predetermined amount of power to be output by the dual fuel engine; and outputting, responsive to the received pre-set command, a first control signal to open or close an air flow valve separating an engine room from an air inlet of the dual fuel engine. In a closed state the valve prevents air from the engine room from passing to the air inlet of the dual fuel engine, and in an open state the valve allows air from the engine room to pass to the air inlet of the dual fuel engine.

Other features and aspects of this disclosure will be apparent from the following description and the accompanying drawings.

### BRIEF DESCRIPTION OF THE DRAWINGS

FIG. 1 illustrates a diagrammatic representation of a locomotive, in accordance with one or more embodiments of the present disclosure;

FIG. 2A illustrates a diagrammatic representation of a locomotive with a system for selectively controlling engine intake air temperature in a “first state,” in accordance with one or more embodiments of the present disclosure;

FIG. 2B illustrates a diagrammatic representation of a locomotive with the system of FIG. 2A in a “second state,” in accordance with one or more embodiments of the present disclosure;

FIG. 3A illustrates a diagrammatic representation of a locomotive with a system for selectively controlling engine intake air temperature in a “first state,” in accordance with one or more embodiments of the present disclosure;

FIG. 3B illustrates a diagrammatic representation of a locomotive with the system of FIG. 3A in a “second state,” in accordance with one or more embodiments of the present disclosure;

FIG. 4A illustrates a diagrammatic representation of a locomotive with a system for selectively controlling engine intake air temperature in a “first state,” in accordance with one or more embodiments of the present disclosure;

FIG. 4B illustrates a diagrammatic representation of a locomotive with the system of FIG. 4A in a “second state,” in accordance with one or more embodiments of the present disclosure; and

FIG. 5 illustrates a flowchart of a method for selectively controlling temperature of engine intake air in the locomotive, according to one or more embodiments of the present disclosure.

### DETAILED DESCRIPTION

The description set forth below in connection with the appended drawings is intended as a description of various embodiments of the described subject matter and is not necessarily intended to represent the only embodiment(s). In certain instances, the description includes specific details for the purpose of providing an understanding of the described subject matter. However, it will be apparent to those skilled in the art that embodiments may be practiced without these specific details. In some instances, well-known structures and components may be shown in block diagram form in order to avoid obscuring the concepts of the described subject matter. Wherever possible, corresponding or similar reference numbers will be used throughout the drawings to refer to the same or corresponding parts.

Any reference in the specification to “one embodiment” or “an embodiment” means that a particular feature, structure, characteristic, operation, or function described in connection with an embodiment is included in at least one embodiment. Thus, any appearance of the phrases “in one embodiment” or “in an embodiment” in the specification is not necessarily referring to the same embodiment. Further, the particular features, structures, characteristics, operations, or functions may be combined in any suitable manner in one or more embodiments, and it is intended that embodiments of the described subject matter can and do cover modifications and variations of the described embodiments.

It must also be noted that, as used in the specification, appended claims and abstract, the singular forms “a,” “an,” and “the” include plural referents unless the context clearly dictates otherwise. That is, unless clearly specified otherwise, as used herein the words “a” and “an” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein, merely describe points of reference and do not necessarily limit embodiments of the described subject matter to any particular orientation or configuration. Furthermore, terms such as “first,” “second,” “third,” etc. merely identify one of a number of portions, components, points of reference, operations or functions as described herein, and likewise do not necessarily limit embodiments of the described subject matter to any particular configuration or orientation.

Generally speaking, embodiments of the present disclosure relate to systems and methods for selectively controlling intake air temperature of the engine. For example, engine intake air temperature can be selectively increased to consume methane and reduce or eliminate “methane slip.” Systems and methods of the present disclosure find application in dual fuel engines, such as diesel-natural gas and heavy fuel-natural gas dual fuel engines.

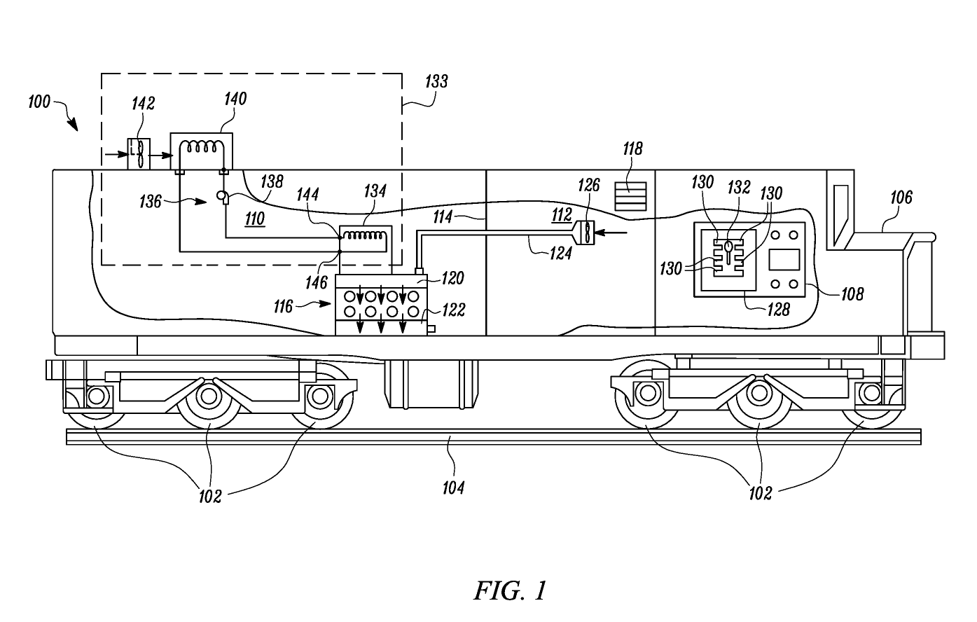

FIG. 1 shows an example of a locomotive 100, in which systems and methods of the present disclosure may be implemented. In the illustrated example of FIG. 1, the locomotive 100 is shown as a rail locomotive. However, the locomotive 100 may take a variety of forms, such as, but not limited to, a mining or an off-highway vehicle. The present disclosure may also be applicable to a marine vessel.

The locomotive 100 includes a plurality of pairs of wheels 102 (only one wheel shown for each pair of wheels 102 in FIG. 1) driven on a track 104. In some embodiments, each pair of wheels 102 may be rotatably coupled to a traction motor (not shown). During powering of the locomotive 100, the traction motors may operate to propel the locomotive 100. It may be understood that in a case of a marine vessel, the wheels 102 may be replaced by propellers or the like, and similarly to tracks or some other form of conveyance for other types of machines.

As illustrated in FIG. 1, the locomotive 100 may include an operator cabin 106. In the illustrated example, the operator cabin 106 is located toward one end of the locomotive 100. The operator cabin 106 may be provided with an operator console 108 having multiple controls for operating the engine 116, and, in general, the locomotive 100. Further, as illustrated, the locomotive 100 may include an engine room 110 and a clean air room 112. In the locomotive 100, such as the rail locomotive of FIG. 1, the engine room 110 and the clean air room 112 may be generally located in proximity to the operator cabin 106. Also, as illustrated, the engine room 110 and the clean air room 112 may be located side-by-side and separated by a partition 114, in the locomotive 100. The shapes, positioning, and relative sizes of the engine room 110 and the clean air room 112, as illustrated in FIG. 1, are for illustrative purposes only and may vary with other engineering requirements of the locomotive 100.

Further, the locomotive 100 includes a dual fuel combustion engine 116 (diagrammatically represented in FIG. 1) positioned in the engine room 110. Hereinafter, the terms “engine” and “dual fuel combustion engine” have been interchangeably used without any limitations. For the purpose of the present disclosure, the engine 116 may be of any suitable type, for example, a spark-ignited or compression-ignited engine, or any other internal or external reciprocating engine. Further, the engine 116 may be a two-stroke engine of diesel-natural gas type. That is, the engine 116 may be operable to work with both the diesel as well as natural gas as fuels.

The engine 116 may function to power the various systems and assemblies of the locomotive 100. The engine 116 may be mechanically coupled to the wheels 102, or may be indirectly coupled via an intermediate electrical generator (not shown) that supplies electrical power to the traction motors which in turn drive the wheels 102. In any case, direct or indirect coupling between the engine 116 and the wheels 102, all fall within the intended scope of the present disclosure.

It may be understood that the engine 116 may have a number of different configurations for dual fuel operation. For instance, one operational configuration may include the engine 116 operating over a broad range of speeds and loads while burning natural gas that is ignited by compression igniting a small pilot injection quantity of liquid diesel fuel. Here, diesel is injected into the combustion chamber shortly before, or at approximately the same time as the natural gas is injected. As diesel will generally auto-ignite under the conditions established within the chamber, the combustion of this diesel will trigger the ignition of the gaseous fuel, such as natural gas.

It is generally known that the power output (or, the horsepower) of the engine 116 is proportional to the product of the angular velocity of a crank shaft (not shown) and the torque opposing the motion of the crank shaft. To vary and regulate the power output, the engine 116 may be equipped with a speed regulating governor (not shown) for adjusting the quantity of pressurized fuel injected into each of cylinders (not shown) of the engine 116, so that the actual speed of the crank shaft (in RPM) corresponds to the desired engine speed. It may be contemplated that in dual fuel engines, such as the engine 116, the engine power output may be controlled by changing a “fuel mode” of the engine 116, for example, by operating the engine 116 using the diesel fuel or a mixture of the diesel fuel and the natural gas fuel, and by further varying the relative quantities of the diesel fuel and the natural gas fuel.

Further, as illustrated in FIG. 1, the clean air room 112 may include an air intake vent 118 for receiving air from the ambient atmosphere. To facilitate the flow of air from the ambient atmosphere into the clean air room 112, the air intake vent 118 may be provided with a suction fan (not shown) to draw the air inside the clean air room 112. In some examples, the air intake vent 118 may be fitted with one or more air filters (not shown) that prevent abrasive particulate matter from entering the clean air room 112 and thus help to keep the air substantially clean for supplying to the engine 116.

Also, as diagrammatically illustrated in FIG. 1, the engine 116 may include an intake manifold 120 and an exhaust manifold 122. The intake manifold 120 may be disposed in fluid communication with the clean air room 112 for receiving air for combustion of the fuel in the engine 116. In some examples, as illustrated, the engine 116 may include an intake duct 124 coupled to the intake manifold 120 at one end, and extending from the engine room 110 into the clean air room 112. The intake duct 124 may be provided with a suction fan, representatively shown and referenced by numeral 126, at another end, and optionally a filter (now shown). The suction fan 126 may be positioned inside the clean air room 112 for sucking air from the clean air room 112 to be transported to the intake manifold 120 of the engine 116 located in the engine room 110, via the intake duct 124. In one example, the intake duct 124 may be supported by the roof of the engine room 110 using brackets or the like.

The operator console 108, provided in the operator cabin 106, may include a throttle control device 128 (diagrammatically shown in FIG. 1). In other examples, the throttle control device 128 may be separate from the operator console 108 and positioned in some other location in the locomotive 100, such as the engine room 110 or the clean air room 112. The throttle control device 128 may include a plurality of throttle notches, commonly referenced by numeral 130, and a throttle handle 132 selectively movable with respect to the throttle notches 130. Hereinafter, the terms “throttle notch” and “notch” have been interchangeably used without any limitations. In one or more embodiments, the throttle control device 128 may include a total of eight discrete throttle notches; labelled as, a first notch, a second notch, a third notch, a fourth notch, a fifth notch, a sixth notch, a seventh notch and an eighth notch for the purpose of this description. In some examples, in addition to the eight throttle notches 130, the throttle control device 128 may also include additional notches (not shown) for an idle position and a braking position of the engine 116.

As schematically depicted in FIG. 1, the throttle control device 128 may be coupled with the engine 116. In particular, the current position of the throttle handle 132, with respect to the notches 130, may be relayed to the engine 116 electrically and/or mechanically. It may be understood that the position of the throttle handle 132 with respect to the notches 130 is varied to define the power output, as desired by the operator of the locomotive 100. A change in the position of the throttle handle 132 from one notch to the next consecutive notch changes the delivered engine power; and certain notch changes in the position of the throttle handle 132 also command a change in the engine speed. In other words, the engine power output is varied (within permissible limits) by selectively moving the throttle handle 132 between the eight throttle notches 130, for example, to the first notch for a low engine power and to the eighth notch for a maximum engine power.

It may be appreciated that the engine power can be, actually, varied by changing the “fuel mode” of the engine 116. For example, when the throttle handle 132 is at the first notch, the engine 116 would be operating at low loads and therefore may not be able to properly combust the natural gas fuel. Therefore, the engine 116 may be supplied with a small quantity of diesel fuel only. When the throttle handle 132 is at the second notch through to the fifth notch, the engine 116 may be supplied with a combination of diesel fuel and natural gas fuel; the quantity of diesel fuel may increase with each higher notch. When the throttle handle 132 is at the sixth notch through to the eighth notch, the engine 116 may be supplied with a relatively large quantity of diesel fuel in combination with or without natural gas; the quantity of diesel fuel may increase with each higher notch and may entirely or mostly include diesel fuel at the eighth notch. The exact amount of diesel fuel and natural gas fuel supplied to the engine 116 for a given engine load may be determined, for instance, by a predefined mapping program stored in Engine Control Unit (ECU) or the like.

As illustrated in FIG. 1, the engine 116 may also include a coolant system 133 to regulate the temperature of the intake air at the intake manifold 120. The coolant system 133 may include an after-cooler 134 disposed in heat exchange relationship with the intake manifold 120 of the engine 116. The after-cooler 134 utilizes a coolant, such as water, to exchange heat with the intake air at the intake manifold 120. In general, the after-cooler 134 facilitates the transfer of heat from the intake air to the coolant.

Further, the coolant system 133 may include a radiator 140 positioned outside of the engine room 110 and in fluid communication with the ambient air, and a coolant circuit 136 to circulate the coolant between the after-cooler 134 and the radiator 140. The coolant system 133 may also include one or more fans 142 to force the ambient air to flow towards the radiator 140, thus cooling the hot coolant coming from the after-cooler 134, to be re-circulated in the coolant circuit 136. The coolant system 133 may further include a pump 138 to aid in the circulation of the coolant in the coolant circuit 136. The pump 138 may be coupled with the engine 116 (as shown in FIG. 1) to draw power for its operation, or alternatively may be battery driven. In some embodiments, the pump 138 may be a variable displacement pump capable of controlling the flow-rate of the coolant from the radiator 140 to the after-cooler 134, and thereby indirectly control the rate of heat exchange between the intake air, at the intake manifold 120, and the coolant.

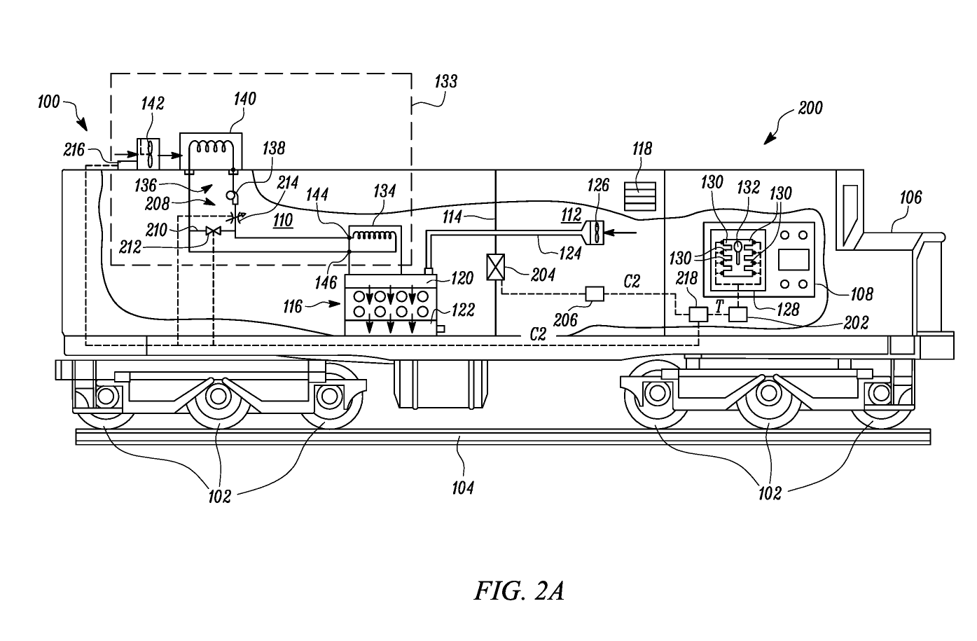

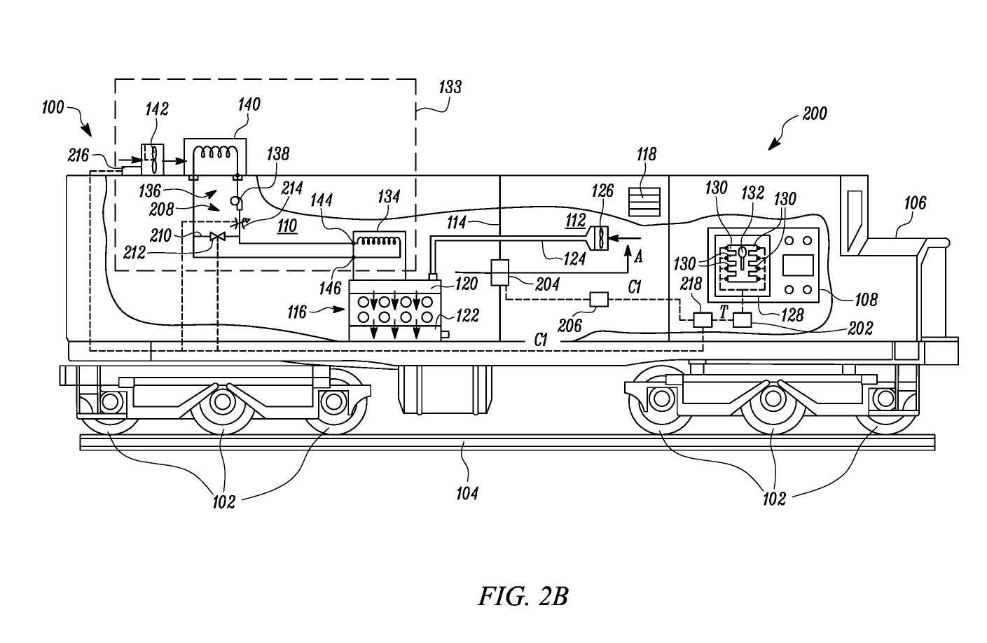

FIGS. 2A and 2B illustrate a system 200 for controlling temperature of the intake manifold 120 according to one or more embodiments, provided in the locomotive 100. Specifically, the system 200 of the present disclosure can control the temperature of the intake air at the intake manifold 120. In particular, FIG. 2A shows the system 200 in a “first state,” and FIG. 2B shows the system 200 in a “second state.” In the “first state,” the system 200 can allow cooling of the intake air based on ambient temperature, for instance, as required for normal operation of a diesel engine for a given engine load condition. In the “second state,” the system 200 increases the temperature of the intake air to be supplied to the cylinders of the engine 116 for combustion of the fuel. The system 200 may include various components and assemblies which are disposed at different locations in the locomotive 100. It may be understood that the size, shape, position, location, etc. of these components and assemblies, as shown in associated drawings, are for exemplary purposes only, and should not be construed as limiting the present disclosure.

In the embodiment of FIGS. 2A and 2B, the system 200 may include a throttle sensor 202 associated with the throttle control device 128. The throttle sensor 202 may determine the position of the throttle handle 132 with respect to the notches 130, and therefore identify the selected notch out of the multiple notches 130 in the throttle control device 128. In one example, the throttle sensor 202 may include multiple relay switches (not shown) associated with each of the notches 130. When the throttle handle 132 is moved to any one notch, the corresponding relay switch may turn ‘ON’; and the throttle sensor 202 generates a throttle signal, generally referenced by ‘T,’ indicative of the selected notch. It may be understood that since the selected notch may define the “fuel mode” of the engine 116, the throttle signal ‘T’ may be indicative of the “fuel mode.” In one or more embodiments, one or more throttle sensors 202 can communicate with ECU(s) to determine and control the “fuel mode” and thus the power output of the engine 116.

Further, the system 200 may include a valve 204 provided between the engine room 110 and the clean air room 112, of the locomotive 100. In particular, the valve 204 may be provided at the partition 114 separating the engine room 110 and the clean air room 112. The valve 204 may allow the flow of hot air, adjacent the engine 116, from the engine room 110 into the clean air room 112. In one embodiment, the valve 204 may be operable between an “open state” and a “closed state.” In some examples, the valve 204 may be an automatic valve, that is, the valve 204 may be operable between the “open state” and the “closed state” based on electrical signals, and without requiring any manual intervention. Further, in one example, the valve 204 may be any one of a gate valve, a slide valve, a shutter, a damper, etc. In one or more embodiments, the valve 204 may be an automatic, pneumatically actuated damper.

The system 200 may further include a valve control circuit 206, associated with the valve 204. The valve control circuit 206 operates the valve 204 between the “open state” and the “closed state” based on one or more commands received from a controller, as explained later. The valve control circuit 206, generally, may be electrically coupled with the valve 204. For example, in a case of a pneumatically actuated valve, the valve control circuit 206 may regulate the pressurized air supplied to the valve 204 by regulating the electric current supplied to the source of the pressurized air or some other means, in order to operate the valve 204 between the “open state” and the “closed state.” In some examples, the valve 204 and the valve control circuit 206 may be formed together as a unitary device.

Further, the system 200 may include an after-cooler control circuit 208, associated with the after-cooler 134 of the engine 116. In some examples, the after-cooler control circuit 208 includes a bypass line 210 associated with the after-cooler 134. The bypass line 210 may connect two points in the coolant circuit 136, located upstream of an inlet 144 and downstream of an outlet 146 of the after-cooler 134, with respect to the flow direction of the coolant. Further, the bypass line 210 may be provided with a valve 212. The bypass line 210 may be used to reduce a flowrate of coolant circulating through the after-cooler 134, by facilitating a portion of the coolant to bypass the after-cooler 134. The amount of coolant bypassing the after-cooler 134 may be regulated by controlling the opening and closing of the valve 212. Generally, some coolant flow may always be provided to the after-cooler 134 in order to avoid damage due to overheating. Likewise, some coolant flow may always be provided to the pump 138.

In one example, the after-cooler control circuit 208 may further include an additional bypass line (not shown) connected between an inlet and outlet of the radiator 140. In some examples, the after-cooler control circuit 208 may also include a flow restriction device 214 associated with the after-cooler 134. The flow restriction device 214 may be provided in the coolant circuit 136 in a line providing the coolant from the radiator 140 to the after-cooler 134. The flow restriction device 214 can independently reduce the flowrate of coolant circulating through the after-cooler 134. The flow restriction device 214 may be in the form of an orifice plate or any other suitable type known in the art.

In some examples, the after-cooler control circuit 208 may further include an air-flow regulating device 216 associated with the radiator 140. The air-flow regulating device 216 can control an amount of air passed through the radiator 140. For example, the air-flow regulating device 216 can reduce a flowrate of air flowing to or through the radiator 140. To achieve this, the air-flow regulating device 216 may reduce a speed of rotation of the one or more fans 142 to reduce the ambient air provided to the radiator 140. In other examples, the air-flow regulating device 216 may also control opening and closing of shutters (not shown), associated with the radiator 140, to regulate the amount of air passing through the radiator 140. It may be contemplated that the after-cooler control circuit 208 may include one, two or all three of the bypass line 210, the flow restriction device 214 and the air-flow regulating device 216, depending on the requirements of the system 200.

Further, as schematically illustrated, the system 200 may include a controller 218. In some examples, the controller 218 may form a part of an Engine Control unit (ECU). In some examples, the controller 218 may also substitute for the valve control circuit 206. As illustrated, the controller 218 may be disposed in signal communication with the throttle sensor 202, as well as the valve control circuit 206 and the after-cooler control circuit 208.

The communication between the controller 218 and other components may be achieved by means of wired or wireless communication standards, such as, but not limited to, Ethernet, Wi-Fi, Bluetooth, infrared, or any combinations thereof. Further, the controller 218 may be a logic unit using one or more integrated circuits, microchips, microcontrollers, microprocessors, all or part of a Central Processing Unit (CPU), Graphics Processing Unit (GPU), Digital Signal Processor (DSP), Field Programmable Gate Array (FPGA), or other circuits suitable for executing instructions or performing logic operations. It will be appreciated that other peripheral circuitry such as buffers, memory, latches, switches and so on may be implemented within the controller 218 or separately as desired.

Various other circuits may also be associated with the controller 218, such as power supply circuitry, signal conditioning circuitry, solenoid driver circuitry, memory circuitry, and other types of circuitry. Further it may be understood that the controller 218 may be associated with a software product stored on a non-transitory computer readable memory (not shown) and comprising data and computer implementable instructions. The non-transitory computer readable medium may include a memory, such as RAM, ROM, a flash memory, a hard drive, etc. The computer readable memory may also be configured to store electronic data associated with operation of the locomotive 100.

The controller 218 may receive the throttle signal ‘T’ from the throttle sensor 202. Further, the controller 218 may process the throttle signal ‘T’ to generate control commands, for instance, a first control command ‘C 1’ and a second control command ‘C2.’ The controller 218 may generate the first control command ‘C1’ when the selected throttle notch 130 is one of the second notch through to the fifth notch, for instance, and/or based on a detected fueling mode of the engine, such as a dual-fuel mode. Similarly, the controller 218 may generate the second control command ‘C2’ when the selected throttle notch 130 is one of the first notch, the sixth notch, the seventh notch or the eighth notch, for instance, and/or based on a fueling mode of the engine, such as a diesel fuel only mode. In some cases, for instance in automated or semi-automated locomotives in which the engine 116 may not employ the throttle control device 128, the controller 218 may generate the control commands based directly on the “fuel mode,” the information about which may generally be received from the ECU. For instance, the controller 218 may generate the first control command ‘C 1’ when the “fuel mode” corresponds to the dual fuel operation of the engine 116, for instance, at low loads; and the controller 218 may generate the second control command ‘C2’ when the “fuel mode” corresponds to either a diesel only fuel operation of the engine 116 or the dual fuel operation of the engine 116 at high loads.

The controller 218 may further transmit the generated control commands ‘C1’ and ‘C2’ to the valve control circuit 206. The valve control circuit 206 is programmed to operate the valve 204 between the “open state” and the “closed state” based on control signals, such as control commands ‘C 1’ and ‘C2.’ For example, the valve control circuit 206 can be programmed to operate the valve 204 from the “closed state” to the “open state” in response to the first control command ‘C1,’ and from the “open state” to the “closed state” in response to the second control command ‘C2.’ In one example, during switching of the selected throttle notch 130 between the second notch and the fifth notch, although the controller 218 may generate the first control command ‘C 1’ each time, however, the valve 204 may briefly go from the “open state” to the “closed state” and then back to the “open state” to let the engine 116 to “settle out.” In the “open state” of the valve 204, hot air adjacent the engine 116, from the engine room 110, is passable through the valve 204, to the clean air room 112, to be provided to the intake manifold 120 for use in combustion of the fuel, via a flow path (as representatively shown by arrow ‘A’ in FIG. 2B). In the “closed state” of the valve 204, hot air adjacent the engine 116 is prevented from passing through the valve 204.

The controller 218 may also transmit the generated control commands ‘C 1’ and ‘C2’ to the after-cooler control circuit 208. The after-cooler control circuit 208 is programmed to reduce at least one of the flowrate and the temperature of coolant circulating through the after-cooler 134 in response to the first control command ‘C1.’ The after-cooler control circuit 208 can reduce the flowrate of coolant by activating at least one of the bypass line 210 and the flow restriction device 214. It may be understood that the bypass line 210 is activated by opening the valve 212 to allow some portion of coolant to bypass the after-cooler 134. Activation of the flow restriction device 214 directly reduces the flowrate of the coolant in the coolant circuit 136. Further, the after-cooler control circuit 208 reduces the temperature of coolant by activating the air-flow regulating device 216. Activation of the air-flow regulating device 216 leads to reduction in speed of the fan 142 and/or closing of the shutters, which in turn reduces the amount of air passing through the radiator 140, and thus less cooling of the coolant or, in other words, increase in temperature of the coolant. The after-cooler control circuit 208 can be programmed to resume a “normal” flowrate of coolant and maintain a “normal” temperature of coolant circulating through the after-cooler 134 in response to the second control command ‘C2.’

The system 200 can be in a “first state,” as shown in FIG. 2A, when the second control command ‘C2’ is generated by the controller 218. In the “first state,” the valve 204 is closed and there is no flow of air through the valve 204, and further the “normal” flowrate and the “normal” temperature of coolant is maintained in the coolant circuit 136. The system 200 is in a “second state,” as shown in FIG. 2B, when the first control command ‘C 1’ is generated by the controller 218. In the “second state,” the system 200 can selectively increase a temperature of the intake air at the intake manifold 120. The system 200 achieves this, by providing hot air from adjacent the engine 116, from the exhaust manifold 122 in the engine room 110, and back to the intake manifold 120 of the engine 116, via the flow path ‘A’ crossing the valve 204, the suction fan 126 and the intake duct 124. Further, the system 200 may additionally reduce the flowrate of coolant and/or increase the temperature of coolant using techniques such as those described above, so that the coolant and the intake air have a reduced heat exchange, and thus increasing the temperature of the intake air.

In some examples, the controller 218 may be configured to determine possible detonation or pinging of the fuel inside the combustion chamber. The controller 218 may achieve this by using readings of various parameters of the operation of the engine 116, and comparing the current parameters with some predefined parameters for the given operation condition. The controller 218 may provide a probability of the possible detonation inside the combustion chamber, and if the probability exceeds a predefined threshold, the controller 218 may generate the second control command ‘C2’ to put the system 200 in “the first state,” and therefore reduce the temperature of the intake air in the intake manifold 120, for instance, bringing the temperature back to its “normal” operating temperature in order to avoid further detonations, and thus eliminating or reducing the chances of possible damage to the engine 116 due to the detonations.

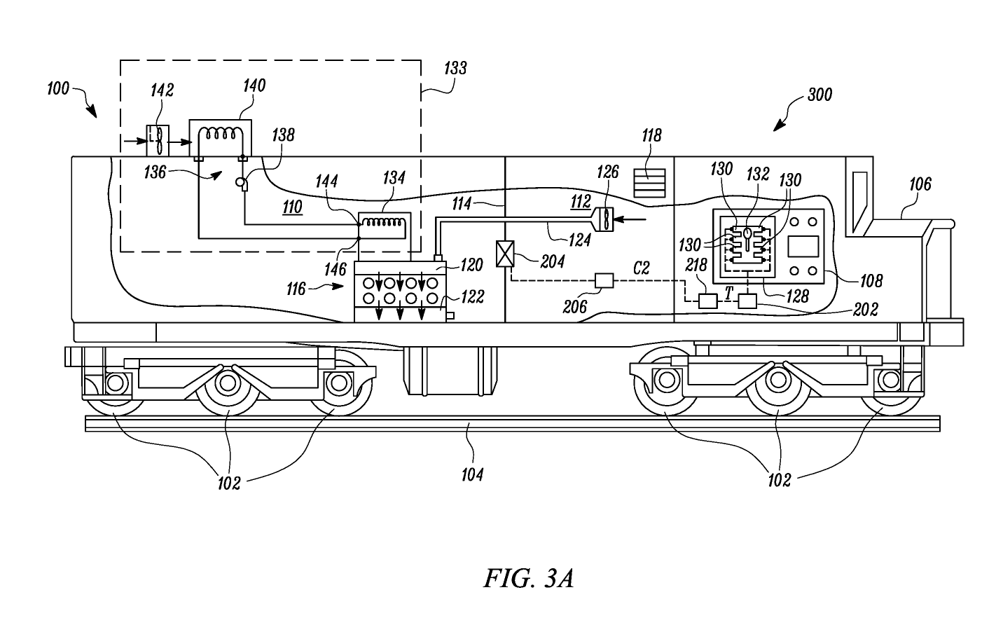

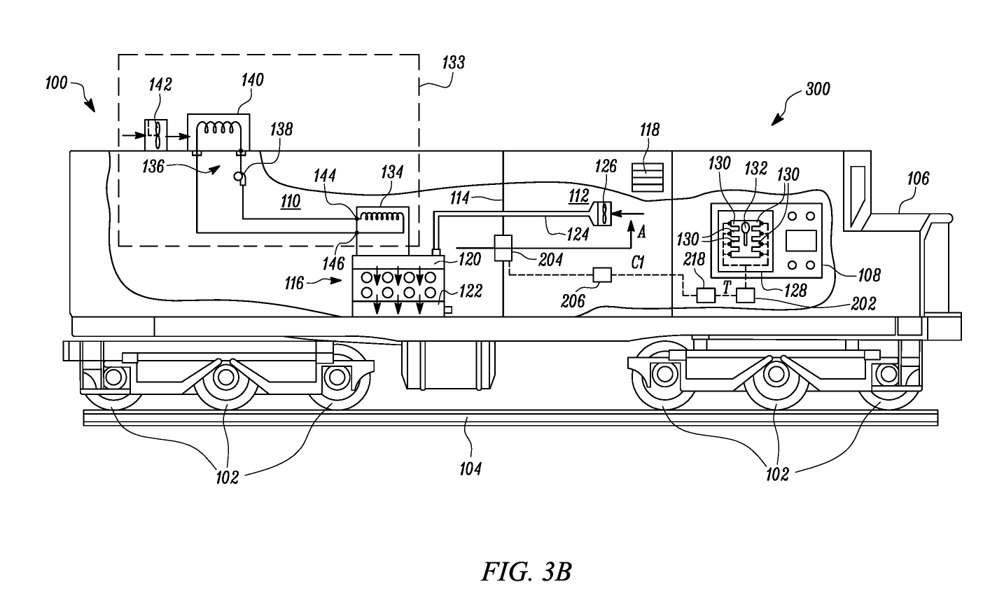

FIGS. 3A and 3B illustrate an alternate embodiment of the system for selectively controlling the temperature of intake air inside the intake manifold 120 of the engine 116, referred to as system 300. The system 300 includes the valve 204 and the corresponding valve control circuit 206, along with the throttle sensor 202 and the controller 218, but omits the coolant system 133 and its associated after-cooler control circuit 208. The system 300 can operate by opening and closing the valve 204 based on the control commands by the controller 218, similar to the system 200 described above. In the “open state” of the valve 204, the hot air adjacent the engine 116 is passable through the valve 204 to be provided to the intake manifold 120 for use in combustion of the fuel. In the “closed state” of the valve 204, the hot air adjacent the engine 116 is prevented from passing through the valve 204, in the system 300.

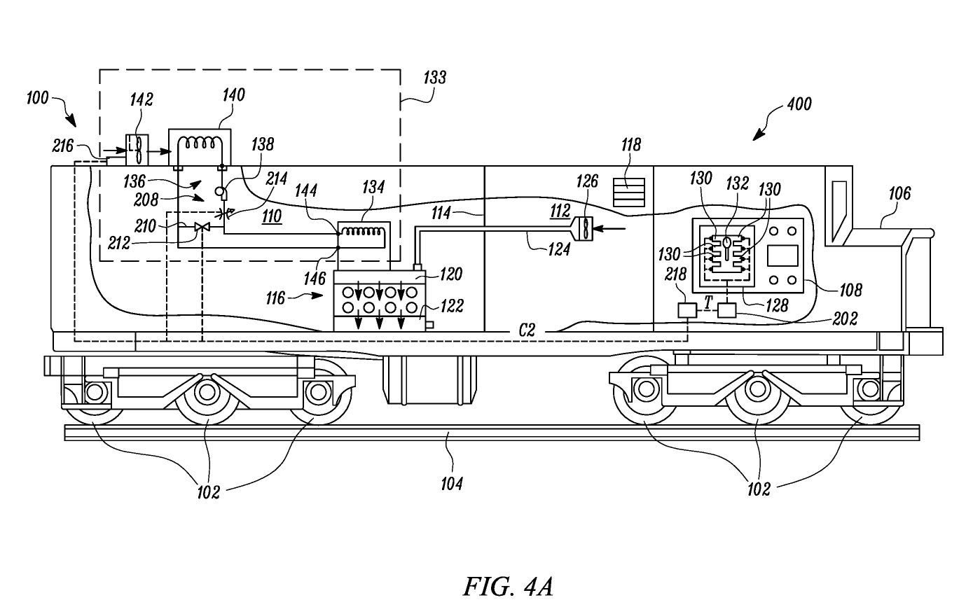

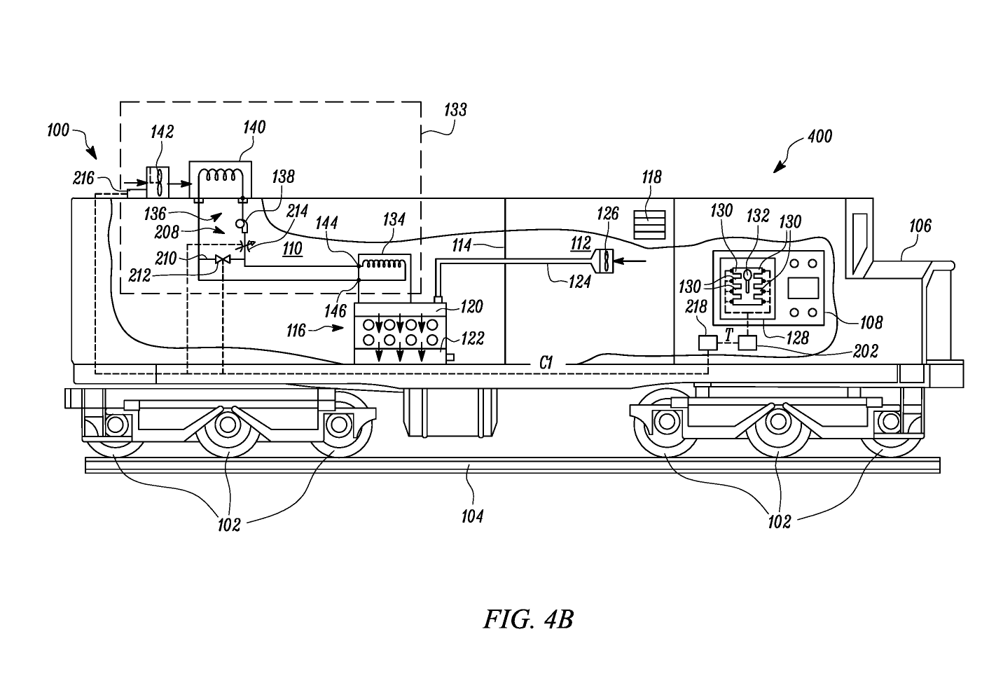

FIGS. 4A and 4B illustrate an alternate embodiment of the system for selectively controlling the temperature of intake air inside the intake manifold 120 of the engine 116, referred to as system 400. The system 400 includes the coolant system 133 and its associated after-cooler control circuit 208, along with the throttle sensor 202 and the controller 218, but omits the valve 204 and the corresponding valve control circuit 206. The system 400 can operate by reducing at least one of the flowrate and the temperature of coolant circulating through the after-cooler 134 in response to the first control command ‘C1,’ and maintain a “normal” flowrate of coolant and a “normal” temperature of coolant circulating through the after-cooler 134 in response to the second control command ‘C2.’

### INDUSTRIAL APPLICABILITY

The present disclosure finds applicability to dual fuel engines that combust liquid diesel fuel, for instance, and natural gas fuel. The present disclosure finds specific applicability to dual fuel engines where there is a desire to limit the emission of the potentially harmful unburnt combustion gases to the atmosphere.

In the context of locomotives or marine vehicles, for instance, when in operation, the engine compression ignites a relatively small quantity of liquid diesel fuel to, in turn, ignite a much larger charge of natural gas fuel. At relatively low loads, when the throttle handle is positioned between the idle and the first notch, the engine may combust a higher ratio of diesel fuel to natural gas fuel than the ratio that could be associated at higher loads. In fact, during idle conditions the engine may utilize no natural gas fuel to maintain operation of the engine. As the engine is operated at slightly higher notches, specifically from second notch to fifth notch, generally a combination of diesel fuel and natural gas fuel is used. It is to be noted that in such condition, the engine is still usually operating at relatively low loads. Therefore, there is a high risk of unburnt natural gas being released along with the exhaust gases because there will be some pockets of natural gas that are too lean to burn or do not get hot enough to combust or the way the fuel exists in the cylinders of the engine. In higher notches, for instance, from the sixth notch to the eighth notch, the engine is again operated at higher volumes of diesel fuel and thus there is less chance of the unburnt natural gas to be released out. It may be understood by those skilled in the art that the “fuel mode” or fueling ratio conditions are somewhat a matter of engineering choice and could vary substantially from one engine to another without departing from the present disclosure.

Natural gas, by way of example, is a clean burning fuel (relative to diesel). Specifically, natural gas, in general, allows engines to operate with reduced emission levels of particulate matter (PM), hydrocarbons, greenhouse gases and nitrogen oxides (NOx). However, natural gas is primarily methane which is regarded as a potent greenhouse gas. Therefore, the emission of unburnt natural gas, a process generally known as “methane slip,” is highly undesirable. One solution to minimize the “methane slip” in dual fuel engines is to preheat the intake air at the intake manifold. This can lead to more complete combustion of natural gas fuel in the combustion chamber and thus help to sufficiently reduce the unburnt fuel in the combustion chamber, specifically when the engine is operating at low loads. However, the dual fuel engines are knock limited engines, that is, there is a low knock margin of operating the engine. Thus, increase in temperature of the intake air may cause pinging or detonations in the combustion chamber of the engine. Generally, in dual fuel engines, the knock or pinging is a result of an abnormal combustion/detonation of injected fuel when the air-fuel mixture in the cylinder gets hot enough to burn on its own. This can cause higher combustion rates and higher pressure rates which can damage the engine.

Although the engine operating at second notch through to fifth notch, for instance, has a relatively high risk of “methane slip,” the engine at such condition also has a relatively high knock margin since the engine is usually operating at low loads and thus running relatively cooler. The present disclosure provides a control strategy which creates a mechanism for trade-off between the knock margin and the “methane slip” in the engine 116. The systems 200, 300, 400 of the present disclosure may only increase the intake air temperature when the engine 116 is operating during dual fuel operation at low engine loads (when there is high tendency of “methane slip”), and may not increase the intake air temperature during diesel operation, or high load in either fuel.

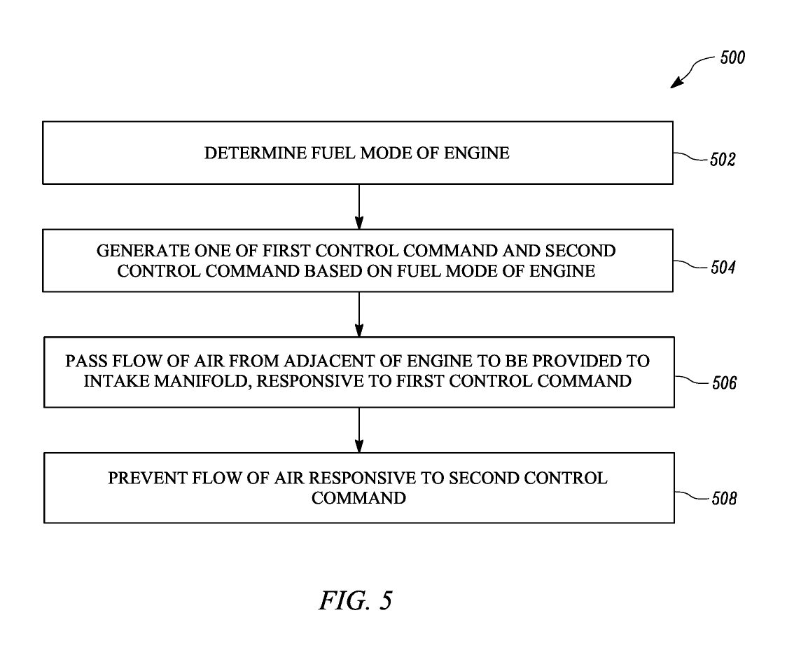

FIG. 5 illustrates a flowchart depiction of a method 500 showing examples of steps or operations to selectively control temperature of intake air inside the intake manifold 120 of the engine 116 according to one or more embodiments of the disclosed subject matter.

In block 502, the method 500 can determine a “fuel mode” of the engine 116. The “fuel mode” may be determined by determining a selected notch, out of the notches 130, or sensing detonation, for instance.

In block 504, the method 500 can include, generating one of the first control command ‘C1’ and the second control command ‘C2’ based on the determined “fuel mode” of the engine 116. As discussed, the first control command ‘C 1’ can be generated when the engine 116 is operating during dual fuel operation at low engine loads to increase engine inlet air temperature, and the second control command ‘C2’ can be generated during diesel operation, or high load in either fuel, to decrease engine inlet air temperature.

In block 506, the method 500 can provide air from adjacent the engine 116 to the intake manifold 120, in response to the first control command ‘C1.’ In block 508, the method 500 can stop the flow of air from adjacent the engine 116 in response to the second control command ‘C2.’ The passing or prevention of flow is achieved by opening and closing the valve 204, respectively.

Additionally or alternatively, the method 500 may regulate the flowrate of coolant in the coolant circuit 136 based on the control command; reducing the flowrate in a case of the first control command ‘C1’ and resuming a “normal” flowrate in a case of the second control command ‘C2.’

Additionally or alternatively, the method 500 may include regulating the temperature of coolant supplied to the after-cooler 134 based on the control command; increasing the temperature in a case of the first control command ‘C1’ and bringing the temperature back to “normal” in a case of the second control command ‘C2.’

Therefore, the system and method of the present disclosure can reduce or eliminate “methane slip,” while, generally speaking, keeping detonation or pinging of the combustion fuel to an acceptable level or amount. It may be contemplated that although the systems and methods of the present disclosure have been described in terms of the dual fuel engine, the present systems and methods may also find applications in single fuel engines, for example to reduce the unburnt fuel emissions in natural gas engines operating at low loads, or the like.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for selectively controlling temperature of intake air inside an intake manifold of a diesel-natural gas dual fuel engine of a locomotive, the system comprising:
control circuitry;
a valve electrically connected to the control circuitry and separating an engine room from a clean air room of the locomotive, the valve being operable between an open position and a closed position, the open position allowing air from the engine room to pass through the valve to the clean air room and the closed position preventing air from the engine room from passing through the valve to the clean air room; and
an aftercooler water circuit electrically connected to the control circuitry,
wherein the control circuitry is configured to
receive a first signal indicative of a power level associated with a notch selected by an operator of the locomotive,
receive a second signal indicating a fueling mode of the engine, the fueling mode being one of a diesel only fueling mode and a dual fuel fueling mode,
control operation of the valve from the closed position to the open position responsive to receipt of the first signal indicative of the power level and the second signal indicating the fueling mode is the dual fuel fueling mode, and
control one or more of water flow through the aftercooler water circuit so as to reduce an amount of water flowing through a engine aftercooler, and airflow to a radiator of the aftercooler water circuit to reduce an airflow rate of air applied to the radiator, responsive to receipt of the first signal indicative of the power level and the second signal indicating the fueling mode is the dual fuel fueling mode.

2. The system of claim 1, wherein the selected notch is one of notches two through five of a plurality of eight total discrete successive notches of the locomotive.

3. The system of claim 1, wherein the control circuitry is configured to control operation of the valve from the open position to the closed position responsive to receipt of the first signal indicative of the power level and the second signal indicating the fueling mode is the diesel fueling mode.

4. The system of claim 1, wherein the control circuitry is configured to control operation of the valve from the open position to the closed position responsive to receipt of the first signal indicative of the power level and the second signal indicating the fueling mode is the dual fuel fueling mode, immediately followed by said control of operation of the valve from the closed position to the open position.

5. The system of claim 1, wherein water flows through the aftercooler and an aftercooler pump when the control circuitry reduces the amount of water flowing through the aftercooler.

6. The system of claim 1, wherein the aftercooler water circuit includes a bypass circuit portion to reduce the amount of water flowing through the aftercooler by providing a path by which a portion of the water flowing through the aftercooler water circuit bypasses the aftercooler when the control circuitry reduces the amount of water flowing through the aftercooler.

7. The system of claim 1, wherein the aftercooler water circuit includes a flow rate restriction device configured to reduce the amount of water flowing through the aftercooler by reducing a flow rate of water to the aftercooler when the control circuitry reduces the amount of water flowing through the aftercooler.

8. The system of claim 1, wherein the control circuitry is configured to control operation of the valve from the open position to the closed position responsive to a detected detonation of injected fuel exceeding a predetermined threshold.

9. The system of claim 1, wherein the control circuitry is configured to control operation of the valve from the open position to the closed position when the selected notch is any one of a first notch, a seventh notch, and an eighth notch of a plurality of eight total discrete successive notches of the locomotive.

10. A system for selectively controlling air temperature at an intake manifold of a dual fuel engine, the system comprising:
a valve separating an engine room from a clean air room, the clean air room having access to an air inlet port to the intake manifold of the dual fuel engine;
a controller configured to determine a fuel mode of the dual fuel engine and generate a control command based on the determined fuel mode of the dual fuel engine; and
a valve control circuit connected to the valve and in signal communication with the controller,
wherein the valve control circuit is configured to operate the valve to an open state, to allow a flow of air from the engine room into the clean air room to be provided to the intake manifold, and to a closed state, to prevent the flow of air from the engine room into the clean air room, responsive to the control command generated based on the determined fuel mode of the dual fuel engine.

11. The system of claim 10, wherein the fuel mode is determined based on input of a pre-set power request to control an amount of power output by the dual fuel engine.

12. The system of claim 10, further comprising an after-cooler control circuit associated with an after-cooler and in signal communication with the controller, the after-cooler control circuit being configured to regulate at least one of a flowrate and a temperature of coolant circulating through the after-cooler responsive to the control command generated based on the determined fuel mode of the dual fuel engine.

13. The system of claim 12, wherein the after-cooler control circuit is configured to regulate both the flowrate and the temperature of coolant circulating through the after-cooler responsive to responsive to a pre-set power request to control an amount of power output by the dual fuel engine.

14. A method for selectively modifying temperature of air inside an intake manifold of a dual fuel engine, the method comprising:
receiving a pre-set command, from among a plurality of pre-set commands, for a predetermined amount of power to be output by the dual fuel engine; and
outputting, responsive to said receiving the pre-set command, a first control signal to open or close an air flow valve separating an engine room from an air inlet of the dual fuel engine,
wherein, in a closed state, the valve prevents air from the engine room from passing to the air inlet of the dual fuel engine, and
wherein, in an open state, the valve allows air from the engine room to pass to the air inlet of the dual fuel engine.

15. The method of claim 14, further comprising outputting, responsive to said receiving the pre-set command, a second control signal to modify a flow rate of coolant to an after-cooler arranged adjacent to the intake manifold.

16. The method of claim 15, wherein said outputting the second control signal causes the flow rate to decrease to a non-zero flow rate.

17. The method of claim 14 further comprising, outputting, responsive to said receiving the pre-set command, a second control signal to modify a temperature of coolant circulating through an after-cooler arranged adjacent to the intake manifold.

18. The method of claim 14, further comprising determining a fueling mode of the dual fuel engine based on the pre-set command, wherein said outputting the first control signal to open or close the air flow value is responsive to the determined fueling mode of the dual fuel engine.

19. The method of claim 14, further comprising:
determining a fueling mode of the dual fuel engine; and
outputting, responsive to the determined fueling mode, a second control signal to one or more of modify a flow rate of coolant to an after-cooler arranged adjacent to the intake manifold, and modify a temperature of coolant circulating through the after-cooler.

20. The method of claim 14, further comprising:
detecting detonation of a fuel injected into the dual fuel engine; and
closing the air flow valve responsive to said detecting detonation.
